(19) United States
(12) Patent Application Publication
(10) Pub. No.: US 2005/0137912 A1
(43) Pub. Date: Jun. 23, 2005

(54) Systems and methods for automated classification of health insurance claims to predict claim outcome

(76) Inventors: R. Bharat Rao, Berwyn, PA (US); William A. Landi, Devon, PA (US); Donald W. Rucker, Philadelphia, PA (US)

Correspondence Address: Siemens Corporation;Intellectual Property Department, 170 Wood Avenue South, Iselin, NJ, 08830, US

(21) Appl. No.: 10/812,589

(22) Filed: Mar. 30, 2004

Related U.S. Application Data
(60) Provisional application No. 60/458,924, filed on Mar. 31, 2003.

(51) Int. Cl. G06F 17/60

(52) U.S. Cl. 705/4

(57) ABSTRACT

Systems, tools, and methods are provided to automatically classify health insurance claims using classification models that are trained to predict whether a health insurance claim will be accepted or rejected by a target payer, analyze why the claim will be rejected, and then target the intervention(s) needed to appropriately handle the claim. Classification schemes are implemented which can automatically and continuously “learn” to predict the outcome of medical claims for target payers by analyzing historical claims results, with minimal or virtually no human expert intervention.

### CROSS-REFERENCE TO RELATED APPLICATION

This application claims priority to U.S. Provisional Application Ser. No. 60/458,924, filed on Mar. 31, 2003, which is fully incorporated by reference.

### TECHNICAL FIELD OF THE INVENTION

The present invention generally relates to systems and methods for providing automated analysis of health insurance claims to predict claim outcome before submission of such claims to the appropriate payers (e.g., health insurance company) for reimbursement. More specifically, the invention relates to systems and methods for automated prediction and classification of health insurance claims using trained classification models for predicting whether a health insurance claim will be accepted or rejected by a target payer and targeting the necessary interventions for appropriately handling the claim.

### BACKGROUND

Due to technological advancements in data storage systems and automated data processing systems, health care providers are migrating toward environments in which many aspects of patient care management are automated or semi-automated. Indeed, health care providers accumulate vast stores of patient data, such as financial and clinical data, which is persistently stored in repositories of electronic patient medical records. And there are various systems, applications and tools, etc., which may be implemented by health care providers for processing and analyzing such patient data to automate or semi-automate certain phases of health care management. For example, medical claims processing is one aspect of patient care management for which tools have been developed to automate/semi-automate transactions between health care providers (such as doctors, hospitals, etc.) and payers (such as HMOs, health insurance providers, etc.).

In general, health care providers will provide health care to patients and then collect revenue from payers by submitting a “bill” (from the provider's perspective) or “claim” (from the payer's perspective). Health care providers submit medical bills to health care payers for claims payment on a highly repetitive basis. Consequently, it is important to implement claim processing methods that are fast and efficient and which minimize the number of medical claims that are “rejected” by the payer (e.g., outright denied downgraded (reduced payment), etc.). Indeed, rejected medical claims result in both providers and payers incurring extra administrative costs. Moreover, from the perspective of providers, rejected medical claims can result in delayed payment or lost revenue.

Traditionally, claims processing has been an entirely manual process with medical claims being manually generated by a provider and manually reviewed by a payer to determine whether to reject or accept the medical claim. However, software systems and tools have been developed which use a combination of automated claim analysis and manual processing to identify rejected claims. These conventional systems and tools are generally referred to as “claim scrubbers” or “claim editors”.

In general, conventional claim scrubber tools implement claim analysis methods that are based primarily on static and pre-programmed (although human extensible) computational techniques. For example, conventional claim scrubber or editor tools are capable of checking the syntactic format of entries (e.g., for a date field, requiring that the entry be in a date format). More advanced features in conventional claim scrubber tools typically implement “hard-wired” analysis methods for identifying rejected claims, which employ a combination of rules, filters, look-up tables, or simple statistical methods such as searching for cost outliers or auditing the highest several percent of claims. With these conventional systems, human domain experts are required for learning and understanding the reasons for claims rejections and manually updating scrubber rules accordingly to provide an acceptable level of rejected claims.

There are various disadvantages associated with conventional claims processing tools such as claim scrubber tools and related applications such as described above. For example, these conventional methods have limited intrinsic accuracy and are imprecise in their performance due to the use of simplistic, hard-wired computational methods. Further, conventional methods are costly to implement and maintain due to the significant time and expense that is required for human experts to understand/learn the basis for claim rejections (for multiple payers) and generate/modify the appropriate rules to efficiently and accurately identify rejected claims. Moreover, while payers will typically provide a basis or reason for rejecting a medical claim, such basis is not always understandable to the provider's domain expert, which can make it a difficult to effectively update scrubber rules.

These disadvantages of conventional claim scrubber tools are exacerbated by the fact that the appropriate set of rules for predicting rejected claims can vary significantly on different levels, such as a regional level or payer level, or even on the level of specific payer/provider relationships. Indeed, each payer (often regional) may have its own justifications for rejecting claims and, thus, one claim scrubber would not work well everywhere. For example, a claim scrubber tool that is optimized for California may be virtually useless in Pennsylvania because of the significantly different factors that are considered for accepting/rejecting medical claims based on regions, payers, and even payer/provider pairs. Therefore, with conventional claim scrubber tools, different rules must be developed and maintained for different regions, for individual providers and even possibly payer/provider pairs.

Furthermore, on a fundamental level, health insurance claims reflect the incredible complexity of human illness and the wide breadth of treatment options provided at hundreds of thousands of provider sites by physicians and other providers in roughly a hundred identified specialties. This complexity is evident by the thousands of ICD (International Classification of Disease) codes that are commonly used to describe medical conditions, as well the thousands of CPT (Common Procedural Terminology) codes commonly used to describe treatments. Other types of standardized coding systems include, for example, HCPCS (health care procedure coding system) codes, DRG (diagnosis related group) codes and APC codes. The breadth and complexity of medical conditions and treatments is another factor that renders it difficult and expensive to capture/automate domain expertise with the conventional approaches to medical claim outcome analysis.

Moreover, on another level, due to complexity of medical conditions and the shortcomings of conventional claim scrubber tools, it is difficult for hospital administrators, for example, to accurately predict their cash flow, namely, the expected compensation from all outstanding claims and the times at which these compensations are needed, which is critical for hospitals and other providers.

### SUMMARY OF THE INVENTION

Exemplary embodiments of the present invention generally include systems and methods for providing automated analysis of health insurance claims, which implement classification schemes to enable more accurate prediction of claim outcome for target payers (e.g., health insurance companies) with minimal or virtually no human domain expert intervention, as compared to conventional methods such as described above.

More specifically, exemplary embodiments of the invention include systems and methods for automated prediction and classification of health insurance claims using classification models that are trained through automated/semi-automated classification techniques to predict whether a health insurance claim will be accepted or rejected by a target payer, analyze why the claim will be rejected, and then target the intervention(s) needed to appropriately handle the claim.

In one exemplary embodiment of the invention, a method for processing medical information includes receiving a medical claim from a health care provider which is to be submitted to a target payer, automatically classifying the medical claim using a classification model that is trained to predict a disposition of the claim by the target payer, and directing the medical claim for further processing based on a classification of the medical claim.

In other exemplary embodiments of the invention, one or more classifiers can be trained to predict various outcomes, including, but not limited to: a probability of medical claims being accepted or rejected by the target payer and a basis for rejecting the medical claims; an expected final compensation for medical claims, wherein the expected final compensation is provided as a distribution of compensations with associated probabilities; an expected time required to accept/resolve medical claims (including an expected time required to provide additional information, or an expected time to modify the medical claims), wherein the expected times to accept/resolve the claims is provided as a probability distribution.

In other exemplary embodiments of the invention, one or more classifiers can provide an expected cash flow for a health care provider by predicting a distribution of expected compensation to be received for all medical claims (or some subset of the claims, for example, for a particular diagnosis code), as well as a distribution of expected times for resolving all the claims. Such prediction may be performed by using a trained classifier to predict the expected compensation/time to resolve for each claim, and summing across the various distributions, or by training one or more new classifiers to directly predict the expected cash flow for a set of claims.

In other exemplary embodiments of the invention, a classification model of a target payer can be trained using training data derived from a history of past resolved medical claims associated with the target payer. The training data may comprise domain-specific criteria in a domain knowledge base. A trained classification model associated with a target payer can automatically updated (continuously or periodically) using data derived from final dispositions of medical claims by the target payer.

Classification models can be trained for implementation on various levels. For instance, classification models can be trained to analyze one or more of a plurality of different target payers of the health care provider, or one or more of a plurality of departments of the target payer. Further, trained classification models can be unique/customized for a health care provider, a target payer, or a healthcare provider/target payer relationship. Further, trained classification models can be unique/customized for one or more target payers in a geographical region, or for particular medical domains (e.g., cardiology, oncology, etc.).

These and other exemplary embodiments, aspects, features and advantages of the present invention will become apparent from the following detailed description of exemplary embodiments, which is to be read in connection with the accompanying drawings.

### BRIEF DESCRIPTION OF THE DRAWINGS

FIG. 1 illustrates a system for automated processing of medical claims according to an exemplary embodiment of the invention.

FIG. 2 is a flow diagram that illustrates a method for processing a medical claim according to an exemplary embodiment of the invention.

FIG. 3A illustrates a method for constructing a classification model that is trained to analyze medical claims and predict claim outcome according to an exemplary embodiment of the invention.

FIG. 3B illustrates a method for automatically updating a trained classification model using information obtained from finally disposed claims, according to an exemplary embodiment of the invention.

### DETAILED DESCRIPTION OF EXEMPLARY EMBODIMENTS

In general, exemplary embodiments of the present invention as described herein include systems and methods (e.g., claim scrubber tools and methods) for providing automated analysis of health insurance claims using classification schemes that can effectively and efficiently predict the outcome/disposition of medical claims that are to be submitted to target payers (e.g., health insurance companies) from health care providers. More specifically, exemplary systems and methods according to the invention can automatically classify health insurance claims using classification models that are trained to determine whether a health insurance claim will be accepted or rejected by a target payer, analyze why the claim will be rejected, and then target the intervention(s) needed to appropriately handle the claim. Systems and methods according to the invention implement classification schemes that can automatically and continuously “learn” to predict the outcome of medical claims by analyzing historical claims results, with minimal or virtually no human domain expert intervention.

It is to be understood that the systems and methods described herein in accordance with the present invention may be implemented in various forms of hardware, software, firmware, special purpose processors, or a combination thereof. In one exemplary embodiment of the invention, the systems and methods described herein are implemented in software as an application comprising program instructions that are tangibly embodied on one or more program storage devices (e.g., hard disk, magnetic floppy disk, RAM, CD Rom, DVD, ROM and flash memory), and executable by any device or machine comprising suitable architecture.

It is to be further understood that because the constituent system modules and method steps depicted in the accompanying Figures can be implemented in software, the actual connections between the system components (or the flow of the process steps) may differ depending upon the manner in which the application is programmed. Given the teachings herein, one of ordinary skill in the related art will be able to contemplate these and similar implementations or configurations of the present invention.

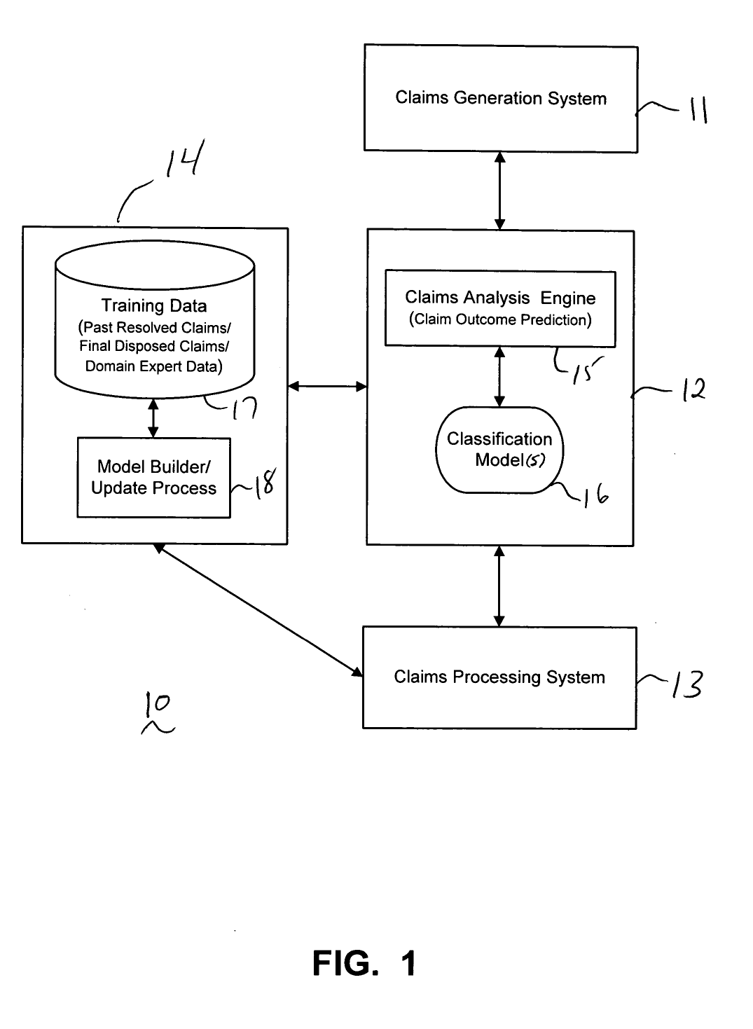

Referring now to FIG. 1, a high-level schematic diagram illustrates a system for processing medical claims (or healthcare insurance claims) according to an exemplary embodiment of the invention. In general, FIG. 1 depicts an exemplary claims processing system (10) comprising a claims generation system (11), a claims analysis system (12), a claims processing system (13), and a training system (14).

The claims generation system (11) is implemented by a healthcare provider for generating medical claims (or health insurance claims) that are to be submitted to appropriate payers (e.g., insurance company) to obtain payment for patient treatment and medical services, etc. The claims analysis system (12) receives and analyzes medical claims output from the claim generation system (11) to predict the outcome/disposition for each medical claim and take the appropriate actions based on the predictions. The claims processing system (13), which is implemented by one or more target payers, receives and processes medical claims that are output from the claims analysis system (12), which are predicted to be accepted by the target payer(s) associated with the claims processing system (12).

The system components/modules (11), (12) and (13) are implemented for effecting “on-line” analysis and processing of medical claims for medical claims that are submitted to a payer (e.g., insurance company) from a healthcare provider (e.g., doctor, hospital, etc.). The training system (14) provides “off-line” training of the claims analysis system (12) and/or “on-line” dynamic learning/adaptation of the claims analysis system (12) using finally disposed claims that are received by the claims processing system (13). Each of the exemplary system components or modules will now be discussed in further detail.

The claims generation system (11) may be a fully automated, semi-automated, or manual system for generating medical bills. The claims generation system (11) may be implemented by healthcare providers such as doctors, hospitals, or other types of health institutions, associations, organizations, etc., for capturing claims during the care/treatment process for various patients and generating medical claims for submission to appropriate health insurance companies. For example, the claims generating system (11) may comprise an application or tool which executes on one or more general purpose or specialized computers, and which provides a suitable user interface for generating medical claims. In one exemplary embodiment, the claims generation system (11) may be implemented using a system or tool that can automatically extract and process billing information contained in databases/repositories of patient medical records and generate medical claims or bills for patients based on the extracted billing information. For example, the claims generating system (11) can be implemented using the systems and methods described in U.S. patent application Ser. No. 10/727,197, filed on Dec. 3, 2003, entitled, “SYSTEMS AND METHODS FOR AUTOMATED EXTRACTION AND PROCESSING OF BILLING INFORMATION IN PATIENT RECORDS”, which is commonly assigned and fully incorporated herein by reference. This application describes systems and methods for automatically extracting billing codes (e.g., ICD code) from structured and/or unstructured patient records, as well as extracting other billing information, for purposes of, e.g., generating, updating, and/or correcting medical claims.

The claims processing system (13) may be a fully automated, semi-automated, or a manual system, which is implemented by a payer (e.g., health insurance company) for processing medical bills (health insurance claims) received from various healthcare entities. For example, the claims processing system (13) may comprise an application or tool which operates on one or more general purpose or specialized computers and which provides a suitable user interface and automated methods for processing and reviewing medical claims from healthcare providers. For purposes of claim adjudication, the claims processing system (13) may include methods that enable data validation, eligibility validation, benefit validation, pricing validation, affliction validation, medical management validation, and fraud/abuse detection, and otherwise ultimately determine whether or not claims should be accepted, rejected, reduced, etc.

In accordance with an exemplary embodiment of the invention, a health provider can utilize the claims analysis system (12) to analyze medical claims generated by the claims generation system (11) prior to sending the medical claims to the appropriate payer. The claims analysis system (12) comprises an engine (15) that implements classification methods for analyzing medical claims using one or more classification models (16) that are trained to effectively and efficiently predict the outcome/disposition of medical claims. More specifically, in one exemplary embodiment of the invention, the engine (15) implements one or more classification models (16) to sort medical claims into specific classes that each can be handled with a targeted intervention.

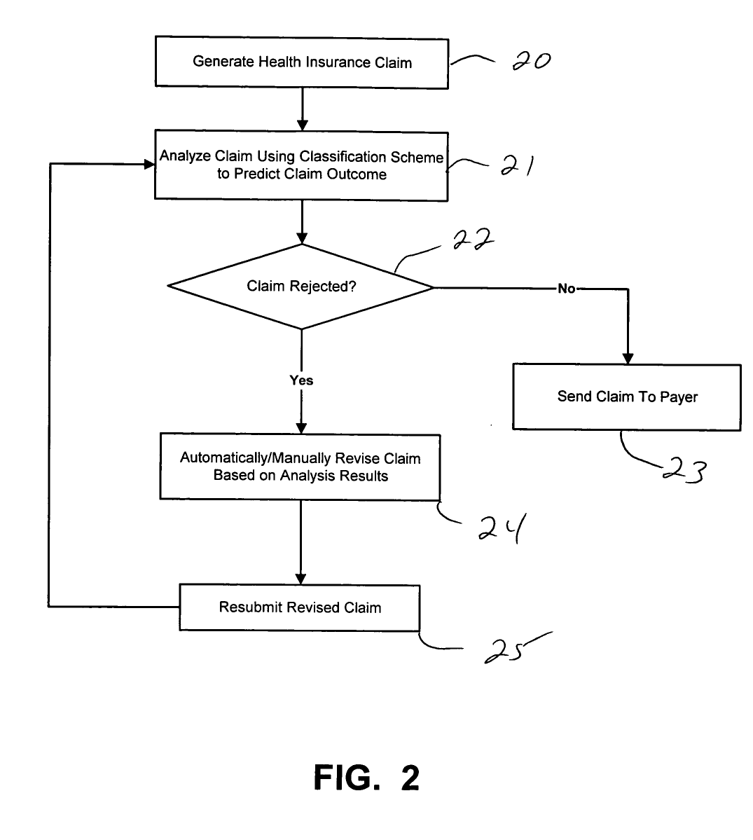

Further, in another exemplary embodiment of the invention, the claims analysis engine (15) implements methods for automated claim handling by commencing one or more appropriate actions or targeted interventions based on the predicted claim outcomes. For example, a medical claim that is predicted/classified as being accepted by a target payer can be automatically transmitted to the target payer. Moreover, a claim that is predicted/classified as being rejected for a particular reason can be directed to an automated system (at the provide cite, for example) that revises or modifies the medical claim, or otherwise augments the medical claim with additional information, based on the classification. Further, a claim that is predicted/classified as being rejected may be directed to a claims processor of the provider to manually revise/augment the claim. Various methods for analyzing/classifying medical claims according to the invention will be described in further detail below with reference to FIG. 2, for example.

It is to be appreciated that the claims analysis system (12) can be implemented as an extension to currently existing claim scrubber tools, whereby the classification models (16) are used (in conjunction with existing scrubbers) as a further filter. Alternatively, the claims analysis system (12) can be a stand alone application that is implemented to replace an existing scrubber, if the performance of the system (12).

The classification models (16) implemented by the claims analysis engine (15) can include models that are trained (and possibly dynamically optimized) to analyze medical claims on various levels including national, regional, payer and payer/provider levels. The training system (14) may be employed for training/updating the classification models (16) using suitable methods. It is to be appreciated that the classification models (16) may be “black boxes” that are unable to explain their prediction to a user (which is the case if classifiers are built using neural networks, example). The classification models (16) may be “white boxes” that are in a human readable form (which is the case if classifiers are built using decision trees, for example). In other embodiments, the classification models (16) may be “gray boxes” that can partially explain how solutions are derived (e.g., a combination of “white box” and “black box” type classifiers). The type of classification models (16) that are implemented will depend on the training data (14) and the model builder (15).

In general, the training system (14) comprises a model builder/update process (18) and a persistent storage repository (17) for maintaining various forms of training data used by the model builder/update process (18) for training classification models, and possibly dynamically updating previously trained classification models that are implemented in the claims analysis system (12).

In one exemplary embodiment of the invention, the model builder/update process (18) is implemented “off-line” for building/training a classification model that learns to predict claim outcomes for a particular payer or payers using training data (17) from a history of past resolved claims associated with the payer(s). In another exemplary embodiment of the invention, the model builder/update process (18) employs “continuous” learning methods that can use training data derived from final claim dispositions obtained from a particular payer to update or otherwise optimize the classification model(s) associated with that payer. In other words, continuous improvement of a classification model can continue based on data even after the classification model has been initially installed. Reinforcement learning techniques can be employed for providing these functions.

Advantageously, a continuous learning functionality adds to the robustness of the claims analysis system (12) by enabling the system (12) to continually improve over time without costly human intervention. For example, continuous improvement enables the system (12) to, e.g., dynamically adapt to changes in payer/provider rules, adapt to new payers or modify predictions for a particular payer as the payer's behavior changes over time. Moreover, system performance can be improved over time based upon “misses” of a previous classifier (e.g., the continuous learning component may be trained on errors or incorrect predictions made by the classifier).

In another exemplary embodiment of the invention, the expertise of a domain expert may be employed to train/optimize a classification model. In particular, in one exemplary embodiment of the invention, a domain expert may directly or indirectly through someone knowledgeable with the training system (14) provide manual input data to the training process using an appropriate interface of the training system (14) to assist in construction and evaluation of classification models. In another embodiment the classification system may be “initialized” based upon rules gleaned by the expert from analyzing previous claims, or from rules and regulations published by an insurance company, for example.

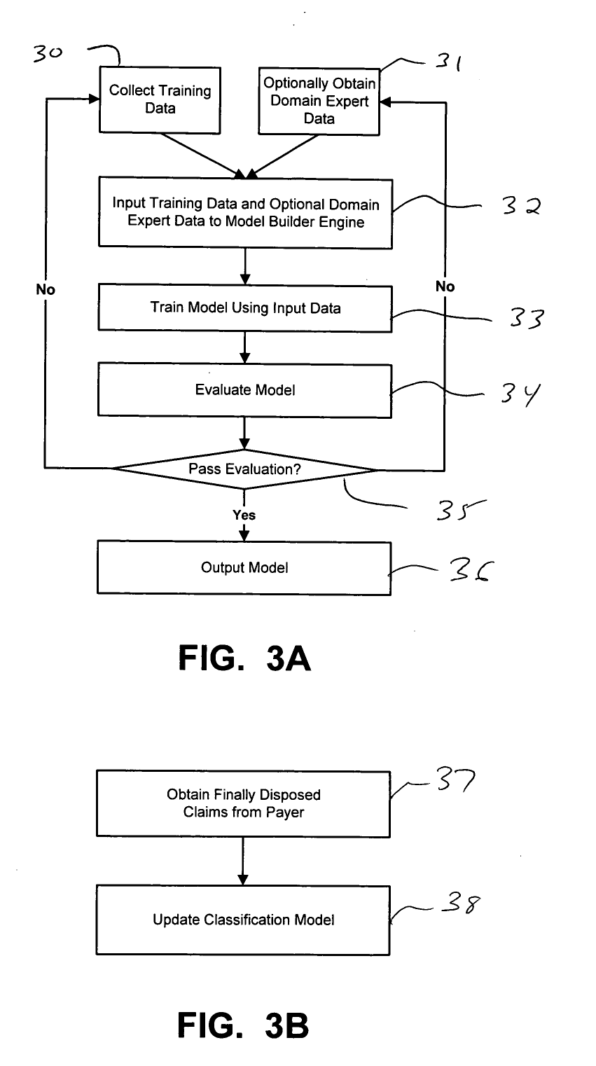

In another embodiment, the repository of training data (17) of training system (14) may comprise domain expert data that is automatically processed by the model builder process (18) during a training/update phase. For example, the domain expert data in repository (17) may comprise a domain knowledge base that is defined using domain-specific criteria for claim processing guidelines of one or more payers. More specifically, by way of example, the domain-specific criteria of a particular payer for processing medical claims can specify the appropriate guidelines and basis for accepting/rejecting various medical claims, and other payer-specific information necessary for analyzing medical claims. The domain expert data in repository (17) can be encoded as an input to the model builder process (18) or as programs that produce information that can be understood by the system (18). Various methods for training and updating classification models will be described below with reference to FIGS. 3A and 3B, for example.

It is to be understood that the system (10) of FIG. 1 may be implemented using a client-server application framework, for example, and any suitable network configuration such as an Intranet, a LAN (local area network), WAN (wide area network), P2P (peer to peer), a global computer network (e.g., Internet), a wireless communications network, a virtual private network (VPN), etc., and any combination thereof.

Moreover, the claims analysis system (12) may reside at various locations including, for example, the provider side where medical bills are prepared or at electronic data interchange intermediaries. In another embodiment, the various systems (11), (12) and (13) may be integrally combined into one system/tool that operates on a provider-side computer system.

In another embodiment of the invention, the claims analysis system (13) can be a service (e.g., Web service) that is offered by a third-party service provider pursuant to service contract or SLA (service level agreement) between payers and providers to provide a secured, confidential service. For example, the third-party service provider can be contractually obligated to train, maintain, and update classification models for various payers, while preprocessing medical claims of various providers.

Those of ordinary skill in the art can readily envision various architectures for implementing the system (10) and nothing herein shall be construed as a limitation of the scope of the invention.

Referring now to FIG. 2, a flow diagram illustrates a method for processing a medical claim according to an exemplary embodiment of the invention. For purposes of illustration, the exemplary method of FIG. 2 may be discussed with reference to the exemplary system of FIG. 1. Initially, one or more health insurance claims (or medical bills) are generated by a provider (e.g., hospital) for submission to one or more payers (e.g., insurance companies) for purposes of reimbursement for medical services, treatment, etc. (step 20).

Before the medical bills are transmitted to the appropriate payer(s), the medical bills will be processed using a classification method to predict the claim outcome (step 21). For example, in one exemplary embodiment of the invention, the medical bill may be input to the claims analysis system (12) where, as discussed above, the medical claims are analyzed using classification methods to predict claim outcome and determine which claims will be rejected and the basis for the rejection. More specifically, in one exemplary embodiment of the invention, the classification methods will automatically examine the input medical claims and then implement the appropriate classification model(s) schemes to categorize the medical claims of interest into subsets of interest. By way of example, a classification process may include methods for identifying a target payer for a given medical claim and implementing the trained classification model(s) that are associated with the target payer to analyze the medical claim and categorize the medical claim based on, e.g., the medical condition, treatments, procedures, etc.

A classification process according to the invention enables a large volume of claims data to be automatically analyzed and sorted into specific classes that are each handled with a targeted intervention. Ultimately, the result of the classification analysis (step 21) is that each claim is classified as “accepted” or “rejected” (for one or more reasons), wherein corresponding target interventions are then implemented to appropriately handle the claims.

For example, if it is determined with a certain degree of certainty (based on the result of the claim classification) that a medical claim will not be rejected by a target payer (negative determination in step 22), the medical claim will be transmitted to the target payer (step 23). The payer will then process the submitted medical claim to make its own determination as to the propriety of such medical claim. As noted above, in one exemplary embodiment of the invention, the provider may subsequently obtain the information regarding the final disposition of the submitted medical claim, and use such information to, e.g., train new classification models or update existing classification models associated with the payer.

On the other hand, a given claim may be ultimately classified as being rejected for a particular reason (affirmative determination in step 22), in which case a target intervention associated with the specific class is implemented to revise/modify the rejected claim (step 24). Depending on the type of modification required, the claims can be further processed using an automated claim adjustment/correction tool, for example. Alternatively, the “rejected” medical claim can be provided to an appropriate claim processor of the provider who will manually review and modify the rejected medical claim. The revised claim can then be resubmitted (step 25) for further classification analysis (return to step 21), wherein the process can be repeated until the medical claim is predicted as being acceptable and then transmitted to the target payer.

A classification process according to the invention can be trained to (or adaptively learn to) identify or otherwise predict rejected claims for various reasons. For instance, a medical claim which is to be submitted to a target payer can be rejected if the medical claim is classified as requiring further information or an attachment, which would be needed by the target payer to properly adjudicate the medical claim. By way of example, a medical claim seeking reimbursement for hospital room charges for 7 days for a given medical condition can be predicted as rejected if the target payer only allows 5 day of room charges for that medical condition, unless justification for the additional two days is provided with the claim. In such case, the medical claim can be rejected as requiring further information to justify the prolonged hospital stay.

Furthermore, a medical claim can be classified as being a claim that would be outright denied by the target payer. For example, an individual's health insurance company may not cover a given medical procedure or treatment. In such case, a medical claim seeking reimbursement for a medical procedure or treatment that is not covered by the individual's insurance plan would be predicted as being outright denied and returned to the payer. In this circumstance, the provider could review the claim to determine if it was generated in error with improper codification, etc, and modify the claim accordingly.

In another embodiment, a medical claim for a particular medical condition and/or procedure may be classified as being rejected for seeking reimbursement in excess of a maximum limit that a target payer will pay for that medical condition/procedure. In such case, the medical claim would be rejected, allowing the provider to, e.g., reduce the medical claim to meet the payer's maximum limit or modify the claim to include other related procedures/conditions that would justify payment in excess of the maximum reimbursement, etc. Moreover, the provider may also decide to submit the full claim, but then only project its revenue based on the expected reimbursement.

Furthermore, a medical claim can be classified as rejected as including an incorrect combination of charges. For example, a claim may be rejected if it includes charges for a combination of items/services (a), (b), and (c) that, e.g., make no medical sense or is simply rejected by the payer (whereas a claim with charges for a combination of (a) and (b), (a) and (c), or (b) and (c), may be valid).

In yet another embodiment of the invention, one or more classifiers can be trained to predict an expected cash flow to the provider (e.g., hospital) and expected time of payment of a plurality of claims. For instance, assume a provider has generated 1000 claims having a total amount of charges of $1,000,000. A classification process may be designed to predict that the provider will be reimbursed $500,000 in one week, an additional $200,000 in 2 weeks, and an additional $200,000 in 3 weeks, and that $100,000 will be lost for particular reasons.

In this regard, one or more classifiers can predict an expected final compensation for all (1000) medical claim (or some subset of the claims, e.g., for a particular diagnosis code). The expected final compensation can be provided as a distribution of compensations with associated probabilities. Moreover, one or more classifiers can predict an expected time required to accept/resolve each of the medical claims (including, for example, an expected time required to provide additional information, and/or an expected time to modify the medical claim). In other words, cash flow can be determined by predicting the distribution of the expected compensation for all (or a set) of medical claims, coupled with a distribution of the expected times to resolve the medical claims. Such prediction may be performed by using a trained classifier to predict the expected compensation/time to resolve for each claim, and summing across the various distributions, or by training one or more new classifiers to directly predict the expected cash flow for a set of claims.

Again, it is to be appreciated that the claims analysis system (12) will learn the above behaviors and rules, for example, by observing the payer's history of accepting/rejecting claims and the system (12) does not have to be explicitly programmed or configured for these behaviors and rules.

FIG. 3A is a flow diagram illustrating a method for training (building) a classification model for claim outcome analysis, according to an exemplary embodiment of the invention. More specifically, FIG. 3A illustrates an “off-line” training method for building/training a classification model according to the invention, which automatically learns from a history of past resolved claims.

More specifically, referring to FIG. 3, an initial step in a training phase according to the invention is to collect a plurality of training data to be used for constructing a classification model (step 30). The type of training data may vary depending on the level of classification required. For instance, as noted above, classification of medical claims (and claim outcome analysis) may be performed on various levels, such as, national, regional, payer, and payer/provider levels. By way of example, classification models can be trained for predicting claim outcome for claims submitted to a governmental benefit program such as Medicare in the United States. Further, classification models can be trained to analyze medical claims for specific health insurance companies.

In such instances, the training data for constructing a classification model for a target payer (or payers) may comprise a wide variety of past resolved medical claims covering various medical conditions, treatments, procedures, etc., which were previously adjudicated by that target payer (or payers). The past resolved claims may comprise a plurality of previously accepted claims and possibly, previously rejected claims, for the target payer. Such training data may be obtained from sources such as a database or repository at the site of the health provider that maintains a history of past resolved claims over the course of dealings with the target payer, or other means.

In another exemplary embodiment of the invention, the training data for building a classification may further (or exclusively) comprise domain expert data (step 31). As noted above, the domain expert data may be obtained by manual input from a domain expert using an appropriate user interface or the domain expert data may be automatically or programmatically input.

The training data and/or optional domain expert data are then input to a model building/training engine (step 32), which processes the input data to automatically build/train a classification model that can be used for predicting claim outcome (step 33). The type of model building process will vary depending on the classification scheme implemented. For instance, classification methods which use models for predicting claim outcome according to the invention may be implemented using classification techniques such as decision trees, support vector machines, probabilistic reasoning, etc., that are known to those of ordinary skill in the art, or other suitable classification methods.

After a classification model is generated, the model will be evaluated (step 34) to determine the efficacy or accuracy of the model for predicting claim outcome (step 34). If the classification model does not pass evaluation (negative determination in step 35), additional training data and/or domain expert data may be collected and the model building process repeated to retrain the model.

For example, the classification model can be evaluated by processing actual training data of medical claims and/or test data of mock medical claims, wherein the claim outcomes are known a priori, and then comparing the classification results against the expected or known outcomes to obtain an accuracy score. In such instance, if the accuracy score falls below a desired threshold, the model will be rejected (negative determination in step 35) and the training process can be continued. If the classification model passes evaluation (affirmative decision in step 35), the model may be output for subsequent implementation for on-line claims processing (step 36).

Furthermore, in another exemplary embodiment of the invention, a classification scheme may include methods providing a learning functionality in which a classification model for a given payer can be continuously or periodically updated or otherwise optimized using information of final dispositions of past claims obtained from the payer. FIG. 3B illustrates a method for automatically and dynamically updating a classification model according to an exemplary embodiment of the invention. In general, after a classification model is trained and implemented for a given payer, medical claims that are ultimately classified/predicted as being accepted by the payer using such classification model are submitted to the payer for the ultimate claim adjudication or disposition. The results of the final claim adjudication/disposition can be obtained from the payer (step 37) and training data can be derived from these claims to dynamically update/adapt the trained classification model for the payer (step 38).

In other words, classification models can be automatically adapted to accurately classify new claims by analyzing past claims and their eventual accepted/rejected status using classification technologies. Since complete claim information is available and since the ultimate final accepted/rejected decision are recorded by the payers, classification techniques have the potential to be highly effective and readily adaptable to preprocess medical claims for the purpose of predicting claim outcome.

It is to be appreciated that systems, methods and tools that implement classification methods for predicting claim outcome according to the invention afford various advantages over conventional tools such as claim scrubbers. For instance, classification models can be readily trained and updated automatically without incurring the costs associated with human analysis.

Moreover, claim scrubber tools that implement classification methods according to the invention can be readily implemented and train/tuned uniquely for specific institutions and departments, or any desired level. For instance, a classification model can be trained to analyze one or more of a plurality of different target payers associated with a provider. Moreover, a classification model can trained to analyze one or more of a plurality of different departments of a target payer associated with a provider. Further, a classification model can be trained such that it is customized/unique to health care provider, one or more payers, or customized/unique for one or more provider/payer pairs. In other embodiments, a classification model can be uniquely trained for one or more target payers in a geographical region. Furthermore, different classification models can be uniquely trained for different medical domains (e.g., cardiology, oncology, etc.). In other words, in accordance with the invention, one or more classifiers can be trained for multiple and/or different levels, and there is no limit on the amount of classifiers, or types of classifiers, that are implemented for predicting claim outcome.

Additionally, claims scrubbers that implement classification methods provide improved claim prediction results that can effectively and accurately identify claims that would be rejected by payers.

Advantageously, the reduction/elimination of manual handling and increased accuracy in claim outcome afforded by the present invention can provide significant benefits and cost savings to both providers and payers. One benefit is the ability to predict cash flow more accurately and recover expenses from the patient. Another benefit is the ability to reduce the amount of human handling for claims processing and reviewing and rule adaptation. A further benefit is the decrease in average account receivable days (AR days). For example, the ability to readily predict that a payer will request additional information or attachment with respect to a medical claim, the provider can save about two weeks in AR (the round trip of sending and receiving the response for the payer). Indeed, each day of average AR can be worth millions of dollars to each provider organization.

Although exemplary embodiments of the present invention have been described herein with reference to the accompanying drawings, it is to be understood that the invention is not limited to those precise embodiments, and that various other changes and modifications may be affected therein by one skilled in the art without departing from the scope or spirit of the invention.

1. A method for processing medical information, comprising the steps of:
receiving a medical claim from a health care provider which is to be submitted to a target payer;
automatically classifying the medical claim using a classification model that is trained to predict a disposition of the claim by the target payer; and
directing the medical claim for further processing based on a classification of the medical claim.

2. The method of claim 1, wherein the step of automatically classifying the medical claim comprises determining a probability of the medical claim being accepted or rejected by the target payer.

3. The method of claim 1, wherein the step of automatically classifying the medical claim comprises classifying the medical claim as accepted or classifying the medical claim as rejected and a basis for rejecting the medical claim.

4. The method of claim 3, wherein the medical claim can be classified as rejected as not covered by the payer.

5. The method of claim 3, wherein the medical claim can be classified as rejected as exceeding a maximum limit of the target payer.

6. The method of claim 2, wherein the medical claim can be classified as rejected for requiring further information or an attachment by the target payer.

7. The method of claim 2, wherein the medical claim can be classified as rejected as including an incorrect combination of charges.

8. The method of claim 1, wherein the step of directing the medical claim comprises sending the medical claim to the target payer if the medial claim is classified as being accepted.

9. The method of claim 1, wherein the step of directing the medical claim comprises sending the medical claim back to the provider if the medial claim is classified as being rejected.

10. The method of claim 1, wherein the step of directing the medical claim comprises automatically modifying the medial claim if the medial claim is classified as being rejected.

11. The method of claim 1, further comprising automatically training a classification model of a target payer using training data derived from a history of past resolved medical claims associated with the target payer.

12. The method of claim 1, wherein the training data further comprises domain-specific criteria in a domain knowledge base.

13. The method of claim 1, further comprising automatically updating a trained classification model associated with a target payer using data derived from final dispositions of medical claims by the target payer.

14. The method of claim 13, wherein automatically updating is performed continuously.

15. The method of claim 13, wherein automatically updating is performed periodically.

16. The method of claim 13, wherein automatically updating comprises re-training new classification model

17. The method of claim 1, wherein the classification model is trained to analyze one or more of a plurality of different target payers of the health care provider.

18. The method of claim 1, wherein the classification model is trained to analyze one or more of a plurality of departments of the target payer.

19. The method of claim 1, wherein the classification model is unique to the health care provider.

20. The method of claim 1, wherein the classification model is unique to the target payer.

21. The method of claim 1, wherein the classification model is unique to the healthcare provider/target payer relationship.

22. The method of claim 1, wherein the classification model is unique to one or more target payers in a geographical region.

23. The method of claim 1, wherein the classification model is unique to a medical domain.

24. The method of claim 1, wherein the step of automatically classifying the medical claim comprises predicting an expected final compensation for medical claims.

25. The method of claim 24, wherein the expected final compensation for the medical claims is provided as a distribution of compensations with associated probabilities.

26. The method of claim 1, wherein the step of automatically classifying further comprises predicting an expected time required to accept medical claims, including an expected time required to provide additional information, or an expected time to modify the medical claims.

27. The method of claim 26, wherein the expected times are provided as a probability distribution with associated probabilities.

28. The method of claim 24, wherein the step of automatically classifying further comprises predicting expected times required to accept the medical claims, including an expected time required to provide additional information, or an expected time to modify the medical claims.

29. The method of claim 28, wherein the expected compensation and times are provided as a probability distribution with associated probabilities.

30. A program storage device readable by a machine, tangibly embodying a program of instructions executable on the machine to perform method steps for processing medical information, the method steps comprising:
receiving a medical claim from a health care provider which is to be submitted to a target payer;
automatically classifying the medical claim using a classification model that is trained to predict a disposition of the claim by the target payer; and
directing the medical claim for further processing based on a classification of the medical claim.

31. A tool for analyzing medical claims, comprising:
an interface for inputting a medical claim; and
an engine that automatically classifies the medical claim using a classification model that is trained to predict a disposition of the medical claim by a target payer, and direct the medical claim for further processing based on a classification of the medical claim.

32. A method for processing medical information, comprising the steps of:
receiving a plurality of medical claims from a health care provider that are to be submitted to one or more target payers; and
automatically predicting an expected cash flow for each medical claim, or a subset of the medical claims, using one or more classification models that are trained to predict a disposition of the medical claims by the one or more target payers.

33. The method of claim 32, wherein automatically predicting an expected cash flow comprises:
predicting an expected compensation for each medical claim;
predicting a resolution time for resolving each medical claim; and
determining the expected cash flow associated with the medical claims by summing the expected compensation and resolution times for the medical claims.
